(19) United States
(12) Patent Application Publication
(10) Pub. No.: US 2006/0113324 A1
(43) Pub. Date: Jun. 1, 2006

(54) Multi-product dispenser and method of using same

(75) Inventors: Brian R. Rudesill, Hudson, WI (US); John C. Nuhlicek, Elk River, MN (US); Mark E. Allegra, Brentwood, TN (US); Alan Keogh, Oakville (CA)

Correspondence Address: PEPPER HAMILTON LLP, ONE MELLON CENTER, 50TH FLOOR, 500 GRANT STREET, PITTSBURGH, PA, 15219, US

(73) Assignee: Niro-Plan AG

(21) Appl. No.: 11/288,478

(22) Filed: Nov. 29, 2005

Related U.S. Application Data
(60) Provisional application No. 60/631,955, filed on Nov. 30, 2004.

(51) Int. Cl. B67D 5/60; B67D 5/64

(52) U.S. Cl. 222/132

(57) ABSTRACT

A dispenser unit for dispensing bulk frozen food items including a cabinet having at least one hopper having a drum, a deflector and flexible gate valve, a dispense assembly and a control system is disclosed. Also disclosed is a method for dispensing bulk frozen food items which includes inserting the bulk frozen food items in a dispenser unit having at least one hopper storage area, transporting the bulk frozen food item to a bottom area of the hopper storage area, dropping the bulk frozen food item from the bottom area of the hopper storage area into a dispense assembly, including a bucket, a dispensing door assembly, a load cell system, a proximity sensor, and at least one basket, and releasing the bulk frozen food items into the at least one basket when the proximity sensor of the dispense assembly detects the at least one basket.

### CROSS-REFERENCE TO RELATED APPLICATIONS

This patent application claims the priority date of U.S. Provisional Patent Application No. 60/631,955 filed Nov. 30, 2004, which is incorporated herein by reference in its entirety.

### BACKGROUND

1. Technical Field

The description contained herein generally relates to an apparatus and method for dispensing of bulk items or products. More particularly, the description in certain embodiments relates to an apparatus and method for automatically dispensing pre-determined portions of bulk food items, such as frozen food items.

2. Description of Related Art

In restaurants, especially quick service (fast food and fast casual) restaurants, fast, consistent, efficient and safe food preparation is essential for a successful operation. One important task frequently required in the preparation of fast food is the portioning of bulk food items supplied in bulk food containers.

Bulk food items are typically supplied in containers weighing several pounds or more. Each container holds a large number of individual food items such as french fries, cheese sticks, chicken nuggets or the like. The use of bulk containers is efficient because it minimizes the number of individual containers which must be transported to, handled and stored at a restaurant. Because it is typically unnecessary, undesirable or impossible to prepare the entire contents of a given container at one time, the bulk food items must be portioned before cooking, heating or serving.

Portioning a bulk food product involves many of the efficiency, speed, safety and consistency considerations involved in fast food preparation generally. For example, consistent food preparation requires that portions be of a uniform size because over- or under-sized portions may yield an under- or over-prepared food product when the portion is cooked, heated or otherwise processed. Additionally, portioning should be performed quickly to minimize food preparation delays which may dissatisfy customers. Furthermore, portioning operations should be non-labor intensive so as to efficiently utilize restaurant labor, particularly when such workers are in high demand and difficult to procure. Finally, portioning operations should minimize the manual manipulation of food products by restaurant workers, thereby minimizing safety concerns related to food handling generally.

Although quick service restaurants have existed for many years and now number in the tens of thousands, these establishments typically continue to utilize labor intensive, manual processes to portion the contents of containerized bulk food products.

Accordingly, a need exists for a commercially suitable portioning apparatus for containerized bulk food items that minimizes manual food handling, requires little operator attention, and quickly, automatically, consistently, and accurately portions bulk food items, while maximizing quality, efficiency, flexibility and yield of the bulk food items, for serving or further preparation.

### SUMMARY

In one embodiment, a dispenser unit dispenses bulk items, such as frozen food items. The dispenser unit may include a cabinet including at least one hopper having a drum, a deflector, a flexible gate valve, a dispense assembly and a control system. The dispenser unit may be a freezer box with a self-contained refrigerator system. The dispense assembly may include at least one bottomless bucket, at least one dispensing door assembly, and at least one receiving basket for collecting a dispensed bulk frozen food item. Additionally, the dispense assembly may include a load cell system and a proximity sensor.

In an embodiment, the bulk frozen food item is introduced into a cabinet of the dispenser unit. The deflector then deflects the bulk frozen food items to a top portion of the drum. The bulk items may rest on a contact area of not more than about 90° between the top portion of the drum and the flexible gate valve. The flexible gate valve may be located opposite to and below the deflector and at a downward angle from a sidewall of the at least one hopper with at least a portion of the flexible gate valve in contact with a portion of the drum. The drum then rotates in a direction to transport the bulk frozen food items from the contact area of the drum past the flexible gate valve towards a bottom portion of the hopper, for example in a clockwise direction. Rotation of the drum continues in one direction until a predetermined or desired weight is satisfied by the load cell system. The at least one bottomless bucket stores the bulk frozen food items delivered by the at least one hopper until the proximity sensor detects the at least one basket in a receiving position at which time the bulk frozen food items may be dispensed.

In an embodiment, the dispenser unit may also include or work with a control panel for automatically and/or manually controlling the dispenser unit. The control panel may be located external to the dispenser unit. The load cell system of the dispenser unit may also be located external to the cabinet on a back portion of the dispenser unit. The load cell system may be calibrated with the initial turning on or initializing of the dispenser unit. Additionally, the cabinet or the dispense assembly may be removable from the dispenser unit to allow for easy and efficient cleaning of the internal and external areas of the dispenser unit.

In another embodiment, a method for dispensing bulk frozen food items includes inserting the bulk frozen food items in a dispenser unit having at least one hopper storage area, comprising a drum, a deflector, and a flexible gate valve. The bulk frozen food items are then transported to the bottom area of the at least one hopper storage area. The bulk frozen food items are dropped from the bottom area of the at least one hopper storage area into a dispense assembly including at least one bottomless bucket, at least one dispensing door assembly, a load cell system, a proximity sensor, and at least one receiving basket. The bulk frozen food items are then released into the at least one receiving basket when the proximity sensor of the dispense assembly detects the at least one receiving basket.

The method may also include the step of rotating the drum in the at least one storage area in a direction that transports the bulk frozen food items to the bottom area of at least one hopper storage area. The inserted bulk frozen food items may rest on a contact area between a top portion of the drum and the flexible gate valve comprising not more than 90° in area. When the load cell system of the dispense assembly satisfies a predetermined or desired weight of bulk frozen food items in the at least one bottomless bucket, the bulk frozen food items may be released into the at least one receiving basket when the at least one dispensing door of the dispense assembly is opened. Additionally, the method may include the step of removing the dispenser unit for cleaning purposes. The dispenser unit may be a freezer box with a self-contained refrigeration unit.

In another embodiment, a dispenser unit for dispensing bulk frozen food items includes a freezer cabinet, a dispense assembly and a control system. The freezer cabinet may include a self-contained refrigeration system including a first and second hopper each having a drum, a deflector, and a flexible gate valve. The flexible gate valve may be located opposite to and below the deflector, with at least a portion in contact with a portion of the drum. The dispense assembly may include a first and second bottomless bucket, a first and second dispensing door assembly and a first and second receiving basket for collecting dispensed bulk frozen food items. The dispense assembly may also include a load cell system and a proximity sensor. The bulk frozen food items may be inserted in the first and second hopper with the bulk frozen food items making contact with the deflector in an area of no more than 90° between a top portion of the drum and the flexible gate valve. The drum may rotate in one direction to transport the bulk frozen food items past the flexible gate valve until a predetermined weight is satisfied by the load cell system which then communicates with the drum. The drum then stops rotating and the bulk frozen food is prevented from traveling past the flexible gate valve. The bulk frozen food items are allowed to then fall into the first and second bottomless buckets, respectively. The first dispensing door assembly then opens to dispense the bulk frozen food items when the proximity sensor detects the first receiving basket. The freezer cabinet and/or the dispense assembly may be removable to allow for cleaning of the dispenser unit.

### BRIEF DESCRIPTION OF THE DRAWINGS

FIG. 1 illustrates a perspective schematic view of an exemplary dispenser unit.

FIG. 2 illustrates a front elevation view of the internal components of a dispenser unit comprising one hopper and one dispense assembly.

FIG. 3 illustrates an enlarged portion elevation view of a hopper and dispense assembly of the dispenser unit of FIG. 3.

FIG. 4 illustrates a perspective view of the dispensing door assembly of the dispenser unit of FIG. 1.

FIG. 5 illustrates a perspective back view of the dispensing door assembly of the dispenser unit of FIG. 1.

FIG. 6 illustrates a back view of a dispenser unit comprising one hopper and one dispense assembly.

FIG. 7 illustrates a back view of the dispenser unit of FIG. 1.

### DETAILED DESCRIPTION OF THE INVENTION

In the following description and accompanying drawings, like reference numbers, as used in the various figures, refer to like features or elements. For purposes of the description hereinafter, the terms “upper”, “lower”, “right”, “left”, “vertical”, “horizontal”, “top”, “bottom”, and derivatives thereof shall relate to the invention, as it is oriented in the drawing figures. However, it is to be understood that the invention may assume various alternative variations and step sequences that the specific devices and process illustrated in the attached drawings and described in the following text are simply exemplary embodiments of the invention. Hence, specific dimensions and other physical characteristics related to the embodiments disclosed hereinafter are not to be considered limiting.

While embodiments are discussed herein in terms of dispensing french fries, the product may be any dispensable item, including for example, frozen food such as patties or nuggets or a vegetable food item other than french fries, any of which might require portioning to a predetermined weight and dispensing them on demand into a receptacle prior to cooking, heating or other processing.

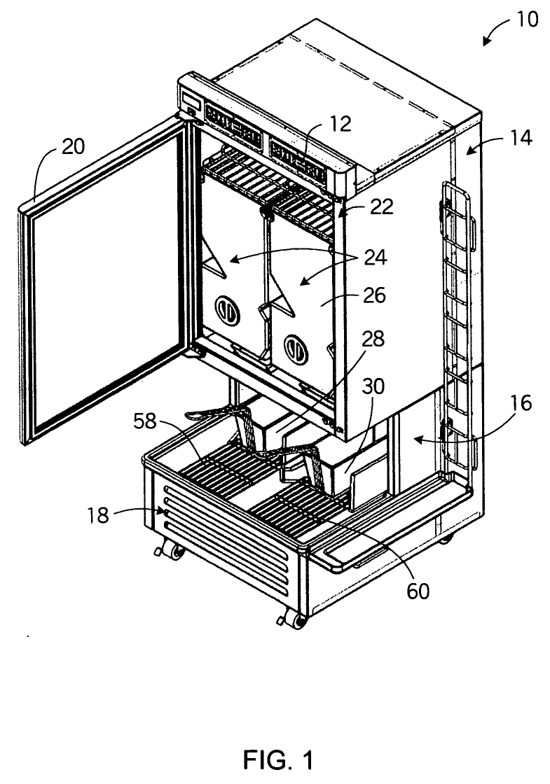

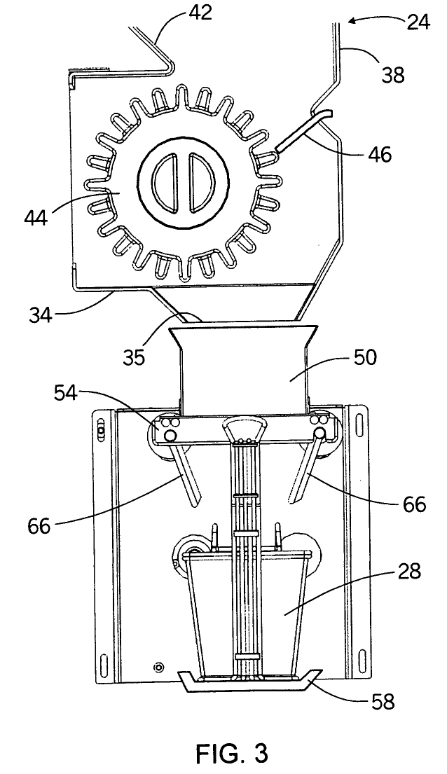

Referring to the drawings in which like reference characters refer to like parts throughout the several views, FIGS. 1-3 depict an exemplary dispenser unit 10 in accordance with an embodiment. The dispenser unit 10 includes a control panel 12, a cabinet 14, a dispense assembly 16 and a self-contained refrigerator system 18. The cabinet 14 may be a freezer cabinet, a refrigerator cabinet, an insulated cabinet, or a cabinet with no temperature control at all, depending on the desired application.

Cabinet 14 having cabinet door 20 provides access to a drum/hopper storage area 22. Hopper storage area 22 supports a first hopper 24 and an optional second hopper 26. Hoppers 24 and 26 are located adjacent to each other. Hopper storage area 22 may also support an additional number of hoppers. Hoppers 24 and 26 are designed to receive a plurality or bulk amount of frozen food, such as french fries. As mentioned above, non-frozen or non-food items may be received in other embodiments. The french fries in hoppers 24 and 26 will eventually be portioned to a predetermined weight and dispensed into one or more receptacles, such as fry baskets or receiving baskets 28 and 30, respectively, as will be described in more detail hereinbelow.

As further illustrated in FIGS. 1-3, each hopper 24 may have a top side 32, bottom side 34 having a feeder opening 35, first sidewall 36 and second sidewall 38. Each hopper 24 may also have front and rear walls between the sidewalls. The walls of the hoppers, including the front wall (not shown) may be opaque, or optionally, partially or fully transparent or semi-transparent to allow for visual observation of the contents of the hoppers. The hoppers may also include a low level sensor which indicates that the contents of the hopper may be below a designated amount and refilling is necessary.

In one embodiment, hopper 24 includes an inlet area 40, a deflector 42, a drum 44, and a flap portion or flexible gate valve 46. The bulk frozen food may be introduced into hopper 24 through the top side 32, the inlet area 40 or any associated area located above deflector 42. Deflector 42 extends from first sidewall 36 at a downward angle to allow the frozen food to be fed towards the drum 44, to a top area of the drum at approximately the twelve o'clock position on the drum. However, deflector may deliver product to other areas, such as approximately an eleven o'clock position or approximately a one o'clock position. Deflector 42 provides deflection of the product onto the top area drum 44, thereby containing the product in a designated area so as to minimize grinding of the product by drum 44.

The flexible gate valve portion 46 extends downward at an angle from second sidewall 38 of hopper 24 optionally at an angle of between about 40° and about 85°, or optionally at an angel no greater than about 80°, although other angles are possible. At least a portion of the flexible gate valve portion is in contact with a portion of the drum when the drum is in a stationary position. Flap portion or flexible gate valve 46 is defined as, but not limited to, a self-adjusting orifice, movable valve, pivoting ridge member and the like. In use, the flexible gate valve 46 maintains the fries in the designated area between the top portion of the drum and the flexible gate valve 46. When the drum rotates in a single direction to transport the fries to the feeder opening 35 of storage hopper 24, the flexible gate valve 46 flexes towards second sidewall 38 of the hopper 24, thereby allowing the fries to drop through to the feeder opening 35. When the drum 44 ceases to rotate, the flexible gate valve 46 returns to its original position with at least a portion in contact with a portion of the drum. The flexibility and/or adjustability of the flap allows for the reduction in breakage of the fries and therefore improves yield and profitability. Flexible gate valve 46 may be made of a flexible material such as rubber or silicone, thereby having the ability to bend or temporarily deform when placed in contact with the fries so as to minimize damage to the fries and allow the fries to fall or be transported to the feeder opening 35 on the bottom side 34 of hopper 24. The flexible gate valve 46 may be removable, and helps aid in the transport of the fries, rather than allowing the fries to fall a greater distance with the potential of breaking.

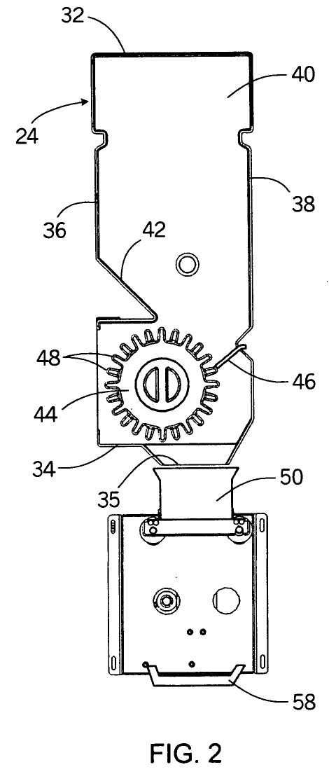

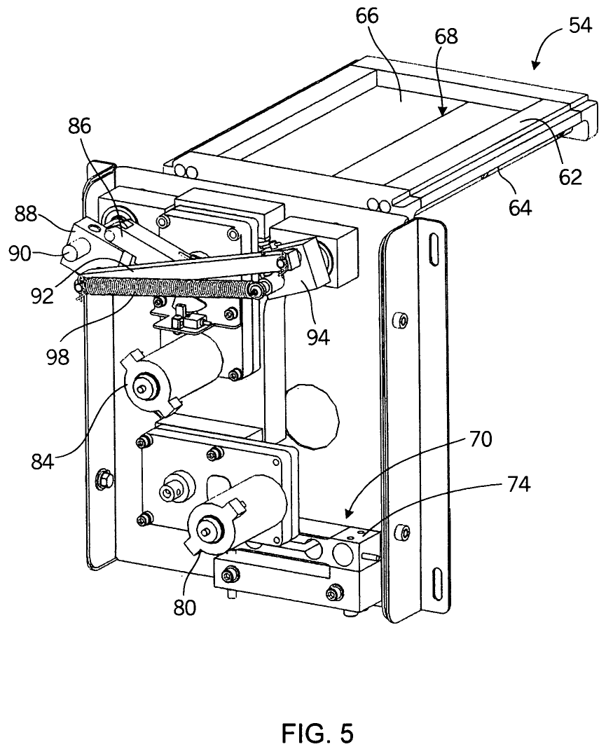

Drum 44 functions in a metering capacity moving in a single direction and includes flights 48 which may be staggered alternatively between the front and back of the drum 44 and extend a portion of the length of the drum 44. In one embodiment, the flights 48 alternate between the front and back of the drum 44 to allow for better accuracy and control of fry disposal. Alternatively, the flights may be evenly distributed around the drum 44. As stated above, the frozen food makes contact with the top portion of the drum 44, for example, the twelve o'clock position. The area between the top portion of the drum 44 and the flexible gate valve 46 defines the contact area of the frozen food with the drum 44. In its original position, flexible gate valve 46 is in contact with a portion of drum 44, such as flights 48. The contact area of the frozen food optionally is an area of no more than about 90°, for example, between the twelve o'clock position to the three o'clock position. Therefore, breakage of the bulk frozen food is minimized since the bulk frozen food may be in contact with about a 90° quadrant portion of the drum 44 thereby not requiring the frozen food to have to travel the entire circumference of the drum 44. In use, the drum 44 rotates toward flexible gate valve 46, for example, in a clockwise direction (as shown in FIG. 2) thereby allowing flights 48 to transport the fries past the flexible gate valve 46, allowing them to then fall by gravity toward the feeder opening 35 of the bottom side 34 of hopper 24. Drum 44 is preferably a nonreversing drum and rotates in a single direction to minimize grinding and breakage of the fries. Drum 44 continues rotating and transporting the fries past the flexible gate valve 46 until the load cell system 70 (as shown in FIG. 5) communicates with drum 44 to cease rotating upon achieving a predetermined or desired weight, as discussed in further detail hereinbelow. Upon the drum 44 ceasing to rotate, the flexible gate valve 46 returns to its original position making contact with at least a portion of the drum 44, for example flights 48. A motor may be utilized to rotate drum 44 and is in communication with the load cell system 70. The motor may be any kind used in the field of art such as and not limited to electric motors, pneumatic motors, hydraulic motors, hand driven motors, for example with a crank or lever-type structure, and the like.

The dispense assembly 16 of FIG. 1, as further illustrated in FIGS. 2-5, includes a bucket 50, dispensing door assembly 54, a fry basket or a receptacle and the like, 28, located on a dispense lane guide 58, load cell system 70 and a proximity sensor 72. The bucket 50 may be bottomless, and provides a path for the fries from the feeder opening 35 on the bottom side 34 of hopper 24 to the fry basket 28, as well as function as a storage area.

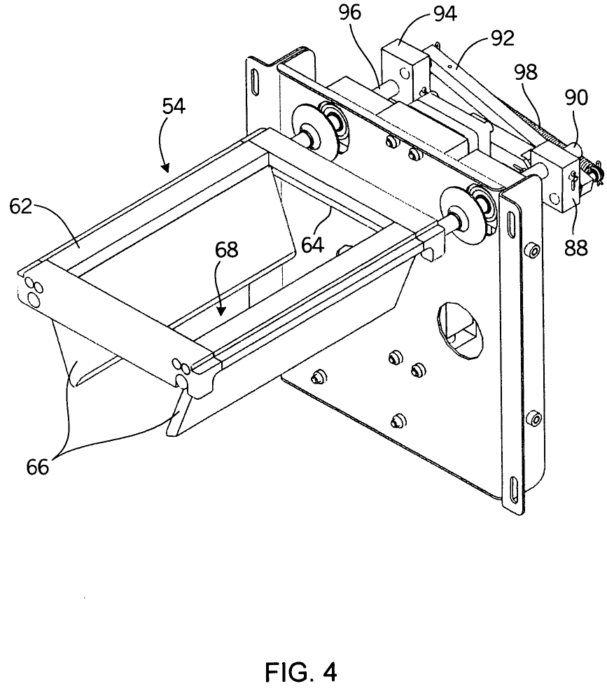

Dispensing door assembly 54 as illustrated in FIGS. 4-5 has a top surface 62, a bottom surface 64 including dispensing doors 66 and a flow through area 68 therebetween. Top surface 62 forms a periphery area around flow through area 68. Edges of bucket 50 rest on or within the periphery of the top surface 62 of dispensing door assembly 54; The dispensing doors 66, when closed, seal the flow through area 68 thereby containing the french fries and restricting their transport to the fry basket 28. When dispensing doors 66 are open, the flow through area 68 allows for fluid communication between the bottomless bucket 50 and the fry basket 28, thereby allowing the fries to be dispensed into fry basket 28. In an alternate embodiment, bucket 50 may be integral with dispensing door assembly 54 such that the dispensing doors 66 form the bottom of each bucket. In the embodiment shown, one bucket is shown for one hopper. Other configurations, such as one bucket for two hoppers, are possible.

Dispensing system 16 further includes load cell system 70 and proximity sensor 72 located external and to the back of the dispenser unit 10. Load cell system 70 includes a load cell 74 associated with dispensing door assembly 54. Particularly, a weight is located on the load cell only when the load cell is weighing the fries, thereby improving the accuracy and longevity of the load cells due to, for example, a lack of constant strain on the load cells. The load cell 74 may be of any type used in the art, such as a strain gauge, pressure transducer and the like. Upon achieving the desired predetermined weight of fries, load cell system 70 communicates with the drum 44 to cease rotation thereby stopping transportation of the fries past flexible gate valve 46 to the feeder opening 35 of hopper 24. The load cell system 70 may be programmed to varying weights to correlate with desired batch sizes of bulk frozen food items.

The presence of the fry basket 28 in dispense lane guide 58 is detected by the proximity sensor 72 thereby allowing for dispensing of the fries. For example, if the fry basket 28 is detected by the proximity sensor 72, the dispensing doors 66 automatically open thereby dropping the fries into the fry basket 28. Upon dispensing the fries into fry basket 28, the dispensing doors 66 close and seal the dispenser unit.

The dispensing door assembly 54 travels up and down the dispenser unit 10. When in a “down” position, the dispensing door assembly 54 is resting on load cell 74, thereby allowing for the rotation of drum 44 to transport the fries past the flexible gate valve 46 from the hopper 24 to the bucket 50 until a predetermined weight is achieved as detected by load cell 74. When bucket 50 achieves a predetermined weight as determined by load cell 74, the load cell system 70 communicates with the motor of drum 44 to cease rotation thereby maintaining the remaining fries within the contact area of drum 44. At this time, if fry basket 28 is detected in dispense lane guide 58 by the proximity sensor 72, the dispensing doors 66 of dispensing door assembly 54 open and the fries are dispensed into the basket 28 with the dispense door assembly 54 in a “down” position. Upon dispensing, the dispensing doors 66 close, and the drum 44 turns again until the load cell 74 weight is achieved. Once the desired weight is achieved, and no fry basket 28 is detected by proximity sensor 72, the dispense door assembly 54 moves up to its original position, sealing the refrigeration unit, and storing the fries in bucket 50 until basket 28 is detected in dispense lane guide 58 by proximity sensor 72. When basket 28 is detected in dispense lane guide 58 by proximity sensor 72, the fries are dispensed from an “up” position with the dispensing doors 66 then closing to reseal the refrigeration unit. Optionally, when dispensing door assembly 54 is in the “up” position, dispensing door assembly 54 moves “down” to rest on the load cell 74 so that bucket 50 may be filled with a predetermined amount of fries and operates in a similar manner as discussed with respect to dispensing door assembly 54. Other variations in the load cell system 70 and the proximity sensor 72 may be used.

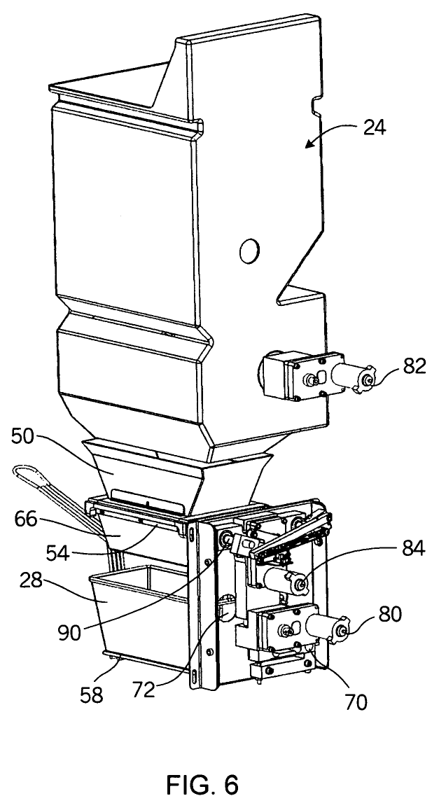

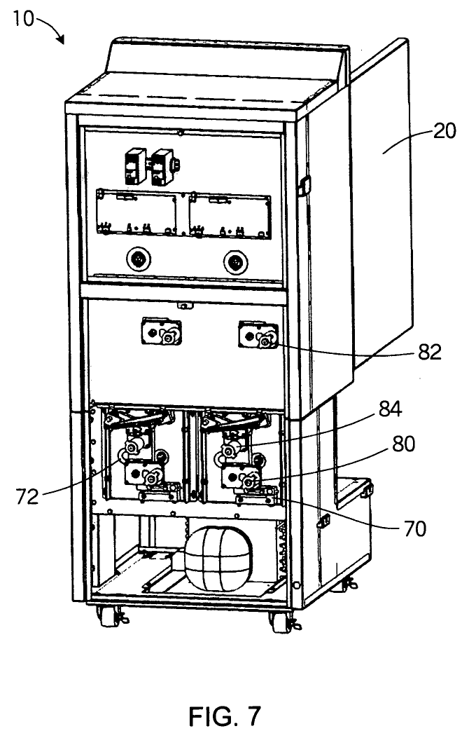

FIGS. 6 and 7 illustrate a back view of the dispenser unit 10. The process described hereinabove is controlled by a control circuit that may be programmable logic controller (PLC) based. Optionally, an integrated circuit board computer, or the like, may also be utilized to control the process.

The controls including the motors, actuation devices, etc., are located external to and on the back of the dispenser unit 10, of the freezer unit. Alternatively, the process may be operated in manual mode rather than being automated. During a manual mode of operation, the dispense unit 10 functions in a similar manner except that the fries will not be dropped into the fry baskets 28 and 30 until a manual dispense button is pressed. The dispenser unit 10 may be changed between manual and automatic mode by a switch. The manual dispense button is only activated after the proximity sensor detects a basket is in the dispense lane guide. Other manual controls, for example, may include batch size control, independent lane controls, low level indicator, LED temperature indicators and the like.

Additionally, the present invention advantageously provides for easy cleaning. The interior parts of the dispenser unit may be removable to facilitate cleaning. In one embodiment, the hoppers may slide out of the dispenser unit to allow cleaning of both the hoppers and drums, as well as the internal area of the freezer. Alternatively, the bottom of the freezer may be removable to allow access for cleaning of the freezer, as well as the dispensing door assembly below.

Exemplary mechanics and controls of a dispenser unit are further described below and are illustrated in FIGS. 5-7.

To begin use of the dispenser unit, in an embodiment, a main power switch may be turned “ON” prior to use. When the dispenser unit comprises a freezer or refrigerator, this starts the refrigeration system and allows the unit to reach the desired temperature such as 0° F. which may take approximately 60-90 minutes, although other time periods are possible. The individual dispenser assemblies 16 may have their own “ON-OFF-Reset” button.

In use, the dispenser unit 10 may work in a manner such as that described henceforth. A product, such as a frozen food product, for example french fries, is introduced into hoppers 24 and 26. The bulk food may be introduced through top side 32 or any portion of the hoppers 24 and 26 as long as it is above the deflector 42. The fries slide down deflector 42 onto drum 44 and are located in a contact area between the top portion of drum 44 and flexible gate valve 46.

When a dispense assembly 16 is then turned “ON”, the dispense door assembly 54 or 56 moves to a lower portion or “down” position via a linear motion slide (not shown) and a motor 80. With the dispensing door assembly 54, 56 in a lower position, it is resting on the load cell system 70. At this time, the load cell 74, 76 may be zeroed or tared. For example, the load cell 74, 76 may be recalibrated to a zero weight after each bulk food dispersal or may be retared after each dispersal to obtain the same weight for each dispersal.

Next, the load cell system 70 communicates with the drum 44 in hoppers 24, 26 to initiate turning by motor 82 which allows fries to pass through flexible gate valve 46 and fall through the void between drum 44 and the flexible gate valve 46 into bucket 50, 52. As drum 44 rotates in a single direction toward the flexible gate valve 46, the flexible gate portion 46 flexes towards second sidewall 38 thereby allowing the fries to pass through towards the feeder opening 35 with minimum breakage. Drum 44 then rotates until the weight on load cell 74, 76 reaches a predetermined weight at which time drum 44 stops turning and the flexible gate valve 46 returns to its original position, whereby the fries are maintained within the contact area of drum 44.

The proximity sensor 72 then detects the presence of basket 28, 30 in the dispense lane guide 58, 60 causing dispensing doors 66 to open, dropping the fries into basket 28, 30. The dispensing doors 66 are opened by actuation of motor 84 which rotates link 86 down which in turn rotates a cam 88 down. The cam 88 is fixed to the dispensing door 66 via a shaft 90. A link 92 fixes the cam 88 to an additional cam 94. The cam 94 is fixed to the opposing dispensing door 66 via a shaft 96. Hence, when the motor 84 turns, it opens both dispensing doors “bomb-bay” style. The dispensing doors 66 are closed via the spring force of extension spring 98. This is a safety feature whereby the pinching force of the closing dispensing doors 66 is no greater than the force applied by the spring. After dropping the fries, the dispensing doors 66 close and the process repeats from the step beginning with the load cell zeroing itself.

Optionally, if a fry basket or other receptacle 28, 30 is not in the dispense lane guide 58, 60, the dispensing door assembly 54 (56—not shown) with the french fries moves up the linear motion slide to the upper position where it awaits fry basket 28, 30. Then when fry basket 28, 30 is placed into the dispense lane guide, it is detected by the proximity sensor 72 and the dispensing doors 66 immediately open, dropping the fries into fry basket 28, 30. After dropping the fries, the process repeats the steps described hereinabove.

The dispenser unit 10 of the present invention is advantageous and may be utilized in any commercial or institutional food service facility such as restaurants, universities, hospitals, catering/banquet/convention halls, etc. Additionally, the invention provides advantages of automatically portioning a predetermined amount of bulk food efficiently in a time effective manner. In particular, the present invention improves the quality and yield of the bulk food item, increases speed, as well as allows for flexibility in the design of the dispenser unit. Additionally, the simple, one-handed operation, and ergonomic controls, as well as the removable parts, provide other advantages. These and other advantages will be recognized by the user.

While the present invention is satisfied by embodiments in many different forms, there is shown in the drawing and described herein in detail, the preferred embodiments of the invention, with the understanding that the present disclosure is to be considered as exemplary of the principles of the invention and is not intended to limit the invention to the embodiments illustrated. Various other embodiments will be apparent to and readily made by those skilled in the art without departing form the scope and spirit of the invention. The scope of the invention will be measured by the appended claims and their equivalents.

What is claimed is:

1. A dispenser unit comprising:
a cabinet comprising a hopper having a drum, a deflector and a flexible gate valve;
a dispense assembly; and
a control system.

2. The dispenser unit according to claim 1, wherein the dispenser unit is a freezer box with a self-contained refrigeration system.

3. The dispenser unit according to claim 1, wherein the flexible gate valve is located opposite to and below the deflector and is located at a downward angle from a sidewall of the one hopper with at least a portion in contact with a portion of the drum when the drum is in a stationary position.

4. The dispenser unit according to claim 1, wherein the drum comprises flights staggered alternatively between a front area and a back area of the drum.

5. The dispenser unit according to claim 1, wherein, when a product is received in the hopper, the deflector deflects the product to a top portion of the drum.

6. The dispenser unit according to claim 5, wherein the product rests on a contact area between the top portion of the drum and the flexible gate valve.

7. The dispenser unit according to claim 6, wherein the drum rotates in a single direction to transport the bulk frozen food items from the contact area of the drum past the flexible gate valve towards a bottom portion of the hopper.

8. The dispenser unit according to claim 7, wherein the drum continues rotating until a predetermined weight on a load cell system is satisfied.

9. The dispenser unit according to claim 1, wherein the dispense assembly further comprises at least one bottomless bucket, at least one dispensing door assembly, and at least one receiving basket for collecting a dispensed product.

10. The dispenser unit according to claim 9, wherein the dispense assembly further comprises a load cell system and a proximity sensor.

11. The dispenser unit according to claim 10, wherein the at least one bottomless bucket stores the product delivered by the at least one hopper until the proximity sensor detects the at least one receiving basket and allows for the product to be dispensed.

12. A method for dispensing bulk frozen food items, comprising:
inserting bulk frozen food items in a dispenser unit having at least one hopper storage area, comprising a drum, a deflector, and a flexible gate valve wherein the bulk frozen food items are received into a bottom area of the at least one hopper storage area;
dropping the bulk frozen food items from the bottom area of the at least one hopper storage area into a dispense assembly comprising at least one bottomless bucket, located on at least one dispensing door assembly, a load cell system, a proximity sensor, and at least one receiving basket; and
releasing the bulk frozen food items into the at least one receiving basket when the proximity sensor of the dispense assembly detects the at least one receiving basket.

13. The method according to claim 12, further comprising the step of rotating the drum in the at least one storage area in a direction towards the flexible gate valve until the load cell system of the dispense assembly satisfies a predetermined weight of the bulk frozen food items.

14. The method according to claim 12, wherein the bulk frozen food items are transported from a contact area of the drum and past the flexible gate valve.

15. A frozen product dispenser unit for dispensing bulk frozen food items comprising:
a freezer cabinet with a self-contained refrigeration system comprising a hopper each having a drum, a deflector and a flexible gate valve, wherein the drum rotates in a single direction to transport the bulk frozen food items from a contact area of the drum past the flexible gate valve towards a bottom portion of the hopper;
a dispense assembly comprising a bottomless bucket, a dispensing door assembly and a receiving basket for collecting dispensed bulk frozen items; and
a control system.

16. The dispenser unit according to claim 15, wherein the flexible gate valve is located opposite to and below the deflector and is located at a downward angle from a sidewall of the at least one hopper with at least a portion in contact with a portion of the drum when the drum is in a stationary position.

17. The dispenser unit according to claim 15, wherein the dispense assembly further comprises a load cell system and a proximity sensor.

18. The dispenser unit according to claim 15, wherein hopper freezer cabinet is removable to allow for cleaning of the dispenser unit.

19. The dispenser unit according to claim 15, wherein the dispense assembly is removable to allow cleaning of the dispenser unit.

20. The dispenser unit of claim 15 further comprising a plurality of cabinet and dispense assembly combinations.
